(19) United States
(12) Patent Application Publication
(10) Pub. No.: US 2016/0077747 A1
(43) Pub. Date: Mar. 17, 2016

(54) EFFICIENT COMBINATION OF STORAGE DEVICES FOR MAINTAINING METADATA

(71) Applicant: Dell Products, LP, Round Rock, TX (US)

(72) Inventor: William Edward Snaman, JR., Nashua, NH (US)

(21) Appl. No.: 14/483,350

(22) Filed: Sep. 11, 2014

(51) Int. Cl. G06F 3/06; G06F 11/14

(52) U.S. Cl. CPC G06F 3/0613; G06F 3/0688; G06F 3/0655; G06F 3/0619; G06F 3/0685; G06F 3/065; G06F 11/1448; G06F 11/1435; G06F 2201/84; G06F 2201/80

(57) ABSTRACT

Multiple storage devices may be used when storing data and metadata. Different types of storage devices exhibit distinct performance characteristics for read/write operations, input/output operations, throughput, latency and the like. Methods and systems described herein identify access patterns and provision a tailored hardware solution which blends the different types of storage to optimize performance and improve efficient use of resources.

### BACKGROUND

The function of magnetic disks relies on mechanical moving parts, which is one of the major threats to device reliability and typically an inhibitor to system performance. For example, Input/Output (IO) performance of hard disk drives (HDDs) has been regarded as the major performance bottleneck for high-speed data processing, due to excessively high latency of HDDs for random data accesses and low throughput of HDDs for handling multiple concurrent requests. Random access performance can be increased by adding more disks and spreading out the workload. Increasing the number of disks both increases system cost and reduces reliability. System reliability can be improved by making multiple copies of the data or using error recovery techniques such as Raid 1, Raid 5, etc.

Flash memory or flash-based drives are built entirely of semiconductor chips with no moving parts. The architectural difference between hard disk drives and flash memory provides the potential to address the performance issues of rotating media but flash based-based drives cost significantly more than rotating drives and generally have less capacity. System reliability can be increased by making multiple copies of the data or using error recovery techniques such as Raid 1, Raid 5, etc, but the cost is significantly more than an equivalent number of rotating drives.

### SUMMARY

Methods and systems may receive access requests for a networked storage array. In one embodiment, the methods and systems may recognize access patterns from the access requests for the networked storage array and blend a primary memory store and a secondary memory store based on the access patterns. The methods and systems may store, in the blended memory stores, metadata associated with the access requests for the networked storage array.

In one embodiment, receiving access requests may include receiving a series of sequential read requests and sequential write requests. Recognizing an access pattern may include identifying a random read access pattern or a sequential write access pattern. In one embodiment, the primary store includes silicon-based memory and the secondary store includes magnetic-based memory. The silicon-based memory may include one or more solid state drives and the magnetic-based memory may include one or more rotating magnetic disk drives.

Methods and systems may maintain metadata associated with the access requests for the networked storage array. For example, methods and systems may maintain object store and file system metadata associated with the access requests for the networked storage arrays. In one embodiment, methods and systems may redundantly store the object store and filesystem metadata in at least two storage devices. According to one embodiment, methods and systems may associate the access requests as one or more access request types. The efficient combination of storage devices may identify primary store and secondary store performance characteristics with this information.

Methods and systems may determine to store metadata associated with the access requests to the primary data store based, at least in part, on the one or more access request types and the primary store performance characteristics. Similarly, methods and systems may determine to store metadata associated with the access requests to the secondary data store based, at least in part, on the one or more access request types and the secondary store performance characteristics.

The efficient combination of storage devices may instantiate an active database resident in a memory, the active database representing at least a portion of a complete database. In one embodiment, methods and systems may instantiate a merge source database resident in the memory, the merge representing a previous version of the active database. The methods and systems may instantiate a persistent database based on the active database and the merge source database. The efficient combination of storage devices may provide the primary storage in one or more solid state drives the secondary storage in one or more magnetic disk drives.

Embodiments of the present invention address disadvantages of the prior art and provide an efficient combination of storage devices for maintaining metadata that increases storage system performance.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic diagram illustrating one embodiment of storage devices for metadata.

FIG. 2 is a schematic diagram illustrating one embodiment of a storage array with a heterogeneous storage device.

FIG. 3 is block diagram of a data flow for an efficient combination of storage devices according to one embodiment.

FIG. 4 is a schematic diagram of a computer architecture according to one embodiment.

FIG. 5 is a flow diagram illustrating one embodiment of a process for a performance enhancing, efficient combination of storage devices.

FIG. 6 is a schematic diagram of a computer system for performance enhancing, efficient storage of storage devices according to one embodiment.

### DETAILED DESCRIPTION

A description of embodiments follows.

The traditional mainstay of storage technology is the hard disk drive. Over time, the capacity of HDDs has increased. However, the random I/O performance of hard disk drives has not increased proportionally. Recently, advances in the types of storage technologies began emerging. One advancement in the types of storage technologies is flash memory or solid state drive (SSD). SSDs offer exceptional performance; however, when compared to hard disk drives, SSDs generally have less capacity per drive and can be cost prohibitive.

Enterprise, web, cloud, and virtualized applications now require increasing capacity and faster performance from their storage solutions. HDDs alone, cannot deliver these increasing capacity and performance demands. The methods and systems described below offer a solution to the problem of effectively and optimally integrating hard disk drives with flash-based solid state drives to meet these increasing demands.

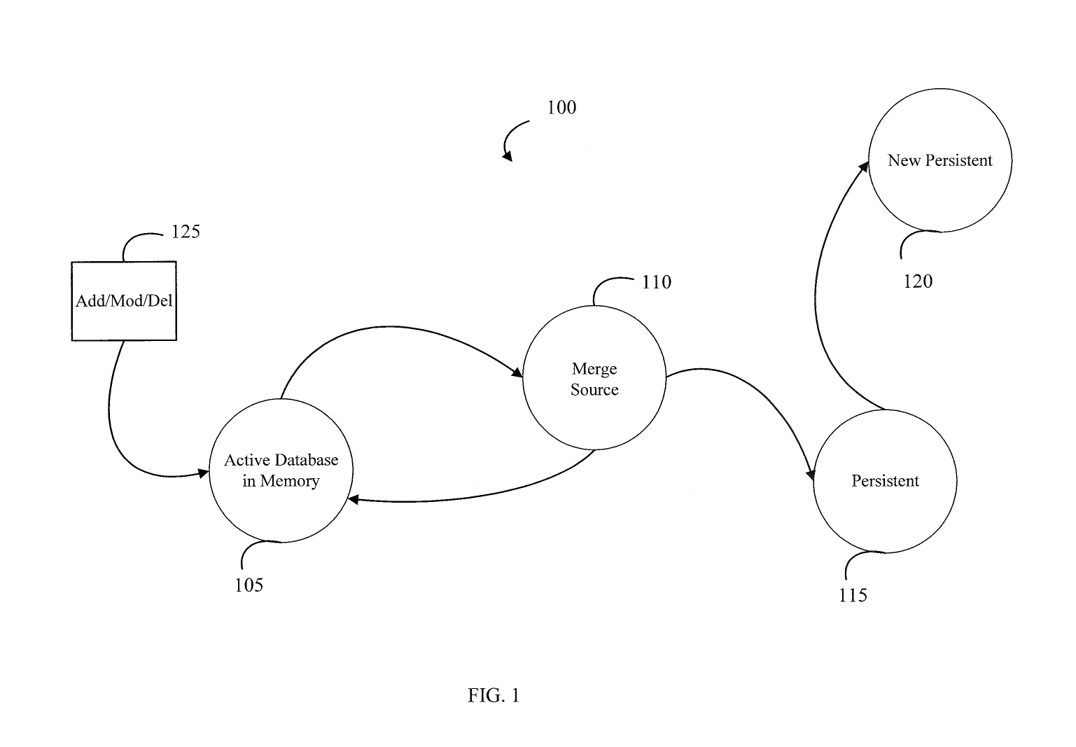

FIG. 1 is a schematic diagram illustrating one embodiment 100 of implementing an efficient combination of storage devices for metadata enhancing system performance. The non-limiting example embodiment 100 includes four database instances. The four database instances may include an Active database 105, a Merge Source database 110, a Persistent database 115 and a new Persistent database 120. Each database instance may be implemented in one or more enclosures having one or more processors, a memory store, e.g., SSD and/or HDD, or a combination thereof. Without limitation, each database instance may be substantially virtualized meaning more hardware is implemented as software (e.g., virtualized processors, virtualized storage, virtualized bandwidth allocations, and/or the like).

The active database 105 is memory resident and initially empty. Changes to the active database are generally made by issuing a command (e.g., a Structured Query Language (SQL) command) to the Active database 105. In one embodiment, the issued command may include an Add, Modify or Delete command or (an Insert, Update, Delete command). These database commands may be issued by an internal controller, (e.g., I/O controller), or by an external controller, (e.g., a client communicating with a database Application Programmers Interface (API)), generally referenced 125 respectively. The active database 105 is implemented to receive internal and/or external changes to data directly and will logically hold the most recent data when compared to the merge source, persistent and new persistent databases, 110, 115 and 120. In one embodiment, a performance enhancing, efficient combination of storage devices maintains object store or file system metadata in a redundant fashion using two persistent storage devices with different performance and cost characteristics.

Examples of such storing metadata in redundant fashion are as follows. Some embodiments can include an object store or filesystem that stores chunks of data in smaller contiguous disk extents where each extent has a Virtual Extent ID assigned to it. A database is used to map the Virtual Extents onto the currently assigned physical addresses. The database consists of records containing Virtual Extent ID, Physical Address, length, and reference count. In one embodiment, the database can be sequentially written and then read randomly. In this embodiment, another (supplemental or second) database can be maintained to track available free disk space. The supplemental (second) database can consist of many records containing a disk offset and length. In another embodiment, a database can maintain deduplicated data and may store chunks of unique data in a container called a datastore. This container may be generated and saved by sequential writing and then randomly read. The metadata can be stored as a mapping table, in one embodiment. The metadata can further include data indicating how to direct read or write requests to drives in the storage array. The metadata can further include the type of drives stored in the storage array, including features such as whether the drive is a SSD, HDD, size of the drive, rotations per minute (rpm) configurations of the drive, and/or power consumption of the drive.

Fast Solid State disk devices and flash memory can have very high random read performance (relative to traditional rotating disks) making SSDs ideal candidates to hold data that is randomly accessed. However, SSDs also tend to be significantly more expensive then rotating disk devices. Rotating disks have fast sequential access performance, slower random access performance, and a lower cost. In one embodiment, multiple storage devices may be utilized when storing metadata and data in order to handle failure of one or more devices, (i.e. RAID -1, RAID -5, etc). Redundancy requires at least 2 devices for RAID-1 and 3 devices for RAID-5 and is thus expensive when fast solid state devices are used.

An efficient combination of storage devices advantageously combines a ratio of very fast Solid State Disks and rotating disks for metadata storage in a way that makes use of the best characteristics of both. Metadata may also be managed and modified in a manner tailored to the efficient combination of storage devices.

A controller (not shown) may facilitate saving the active database and to reduce the amount of memory required to hold the full database in memory. This can be accomplished by using a persistent database 115 and a merge source database 110. In one embodiment, the persistent database 115 is saved on disk and the merge source 110 is memory resident. Both can be randomly accessed but are never modified. A new persistent 120 database is created by sequentially reading a previous persistent database 115 and merging in the merge source 110. The resulting new persistent database 120 is generally written sequentially.

New and modified items are generally placed in the active database 105. Lookup of existing items is first done in the active database 105, then the merge source 110, and then the persistent database 115 (this will find the most recent value of an existing item). When an item is found, it is loaded into the active database 105 to ensure that a newer copy does not already exist. If the item needs to be modified its new value is generally updated in the active database 105.

As the items are added, modified or deleted, the active database 105 grows and eventually some or all of the active database needs to be saved to persistent storage 115. This process is accomplished by creating a new empty active (in memory) database and swapping the active database 105 with this new database. The new database becomes the active database 105 and the old database becomes the merge source 110, the permissions of which are set to read-only.

At this point, there is an empty active database 105 and a populated merge source 110. New items are added to the active database 105 and lookups can be done on the merge source 110. If the item is not in the merge source 110, a lookup can be done on the persistent database 115 if it exists. If an item needs to be read, the item is first added to the active database 105 to ensure that a more recent version does not exist. If an item in the merge source 110 needs to be modified (or deleted), the item is first added to the active database 105 and then modified. Items thus promoted from the merge source 110 or the persistent database 115 to the active database 105 are marked as persistent so that they are preserved as zombie entries upon deletion. Newly created items are marked as dirty to ensure that they are saved. When an item marked as persistent for the active database 105 is modified, it is also marked as dirty so that it is saved. Items that are not marked dirty or zombie can be removed from the active database 105 to save space since an up to date copy already exists in the merge source 110 or persistent database 115.

The read-only merge source 110 is merged with the persistent database 115 on disk. If no persistent database 115 exists, then the merge source 110 is simply written out to disk. Once a persistent database 115 exists, then merge source 110 is merged item by item with the persistent database 115 creating a new persistent database 120. The items in the merge source 110 are the most recent values of items in the persistent database 115. The existing persistent database 115 is then deleted. Zombie items in the merge source 110 are used to remove items in the existing persistent database 115.

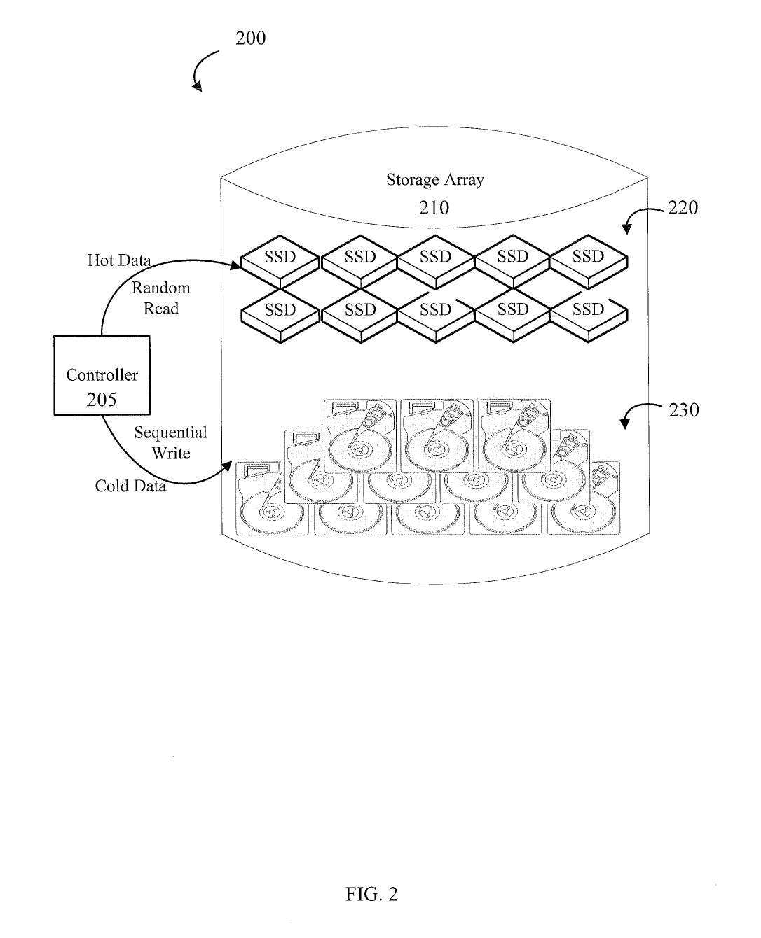

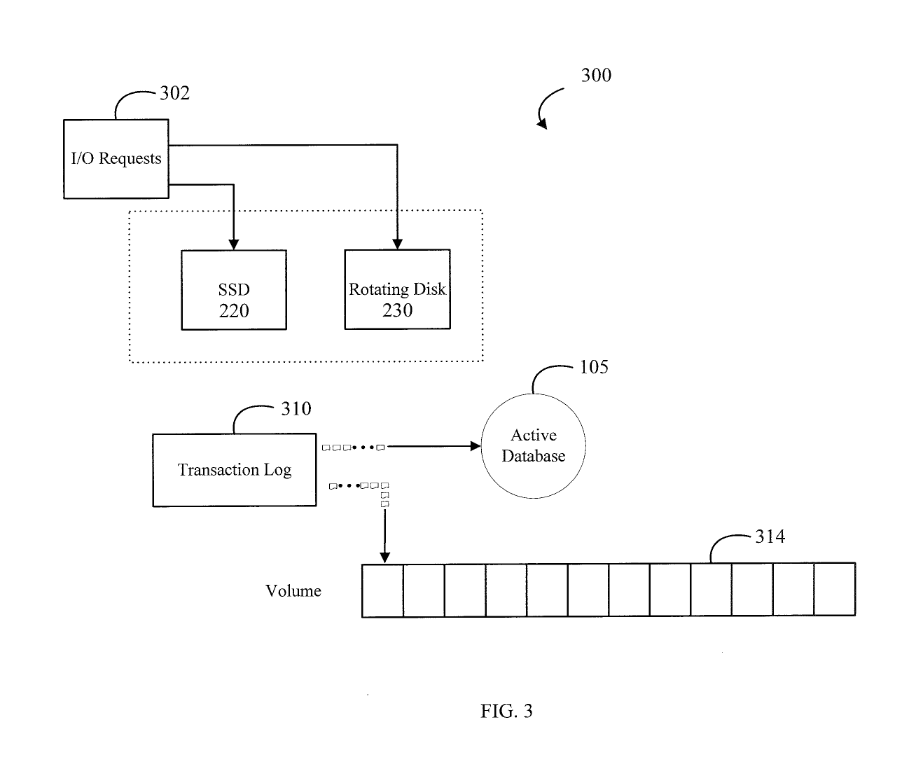

A Persistent database 115 may be mirrored between a fast Solid State Disk (SSD) 220 and a slow rotating disk 230 as show in FIGS. 2 and 3. Random lookups of the persistent database 115 are performed optimally by directing them to the fast SSD 220. Updates of the persistent database 115 are accomplished by sequentially reading the current persistent database 115 from the rotating disk 230 (or SSD 220) and sequentially writing the result of the merge to both the SDD 220 and the rotating disk 230. Once the updated new persistent database 120 is written to disk memory, that part of the disk memory becomes the new persistent database 120 and the existing one 115 is deleted.

Advantages of the efficient combination of storage devices 220, 230 include runtime random access of the database using SSD(s) 220 optimized for enhanced random read performance. Redundancy may be provisioned by using an SSD 220 and a rotating disk 230 at a cost that is significantly lower than 2x the cost of having 2 SSDs. With this redundancy, either the SSD 220 or the rotating media 230 can fail and system operation continues (at reduced performance if the SSD fails). Updates to the persistent database 115 may be performed with sequential reads and writes with a rotating disk 230 optimized for sequential read/write requests.

FIG. 2 is a schematic diagram illustrating one embodiment of 200 a storage array with a heterogeneous storage device set. The non limiting example embodiment of system 200 includes a controller 205, a storage array 210, a group of SSDs 220 and a group of HDDs 230. In one embodiment, the controller 205 ensures the storage array 210 maintains hot data, (data frequently accessed or requested) in one or more SSDs within the group of SSDs 220. Hot data may also be defined by the type of access request (e.g., Random Read request), since SSDs are particularly suited for this type of access request. Similarly, the controller 205 may ensure the storage array 210 maintains cold data (data less frequently accessed or requested). Cold data may also be associated with an access request type (e.g., sequential write), which HDDs 230 are particularly suited for. In one embodiment, the SSDs 220 are configured to take advantage of the speed of accessing any portion of data, such as a random read, a relatively small random read or non-sequential write requests, due to their non-mechanical nature by accessing such hot data. The HDDs 230 are configured to handle sequential write or read requests (e.g., a relatively large sequential write request) that are more suited to the HDDs 230 mechanical nature. Sequential writes and read requests are faster on HDDs 230 than non-sequential write or read requests because sequential requests move the head of the HDDs 230 to the next block instead of to a random block.

FIG. 3 is a block diagram of a data flow for the efficient combination of storage devices of FIG. 2 according to one embodiment. The illustrated system data flow 300 includes I/O requests 302 being propagated to an SSD 220 and/or a rotating disk (HDD) 230. Changes to an Active database 312/105 may be transmitted to a transaction log 310. In one embodiment, the transaction log 310 may also be used to write a logical/physical volume 314. For example, transaction log 310 may include a log for each database instance 105, 110, 115, and/or 120 described in FIG. 1. Accordingly, the data flow 300 may include reading from an active database log portion of transaction log 310 to populate the merge source database 110. A merge source transaction log part of log 310 may be read to populate the persistent database instance 115 and the persistent database log part of log 310 may be read to populate the new persistent database 120. In one embodiment, each log entry (of log 310) may be used to restore its predecessor database instance 105, 110, 115, and/or 120.

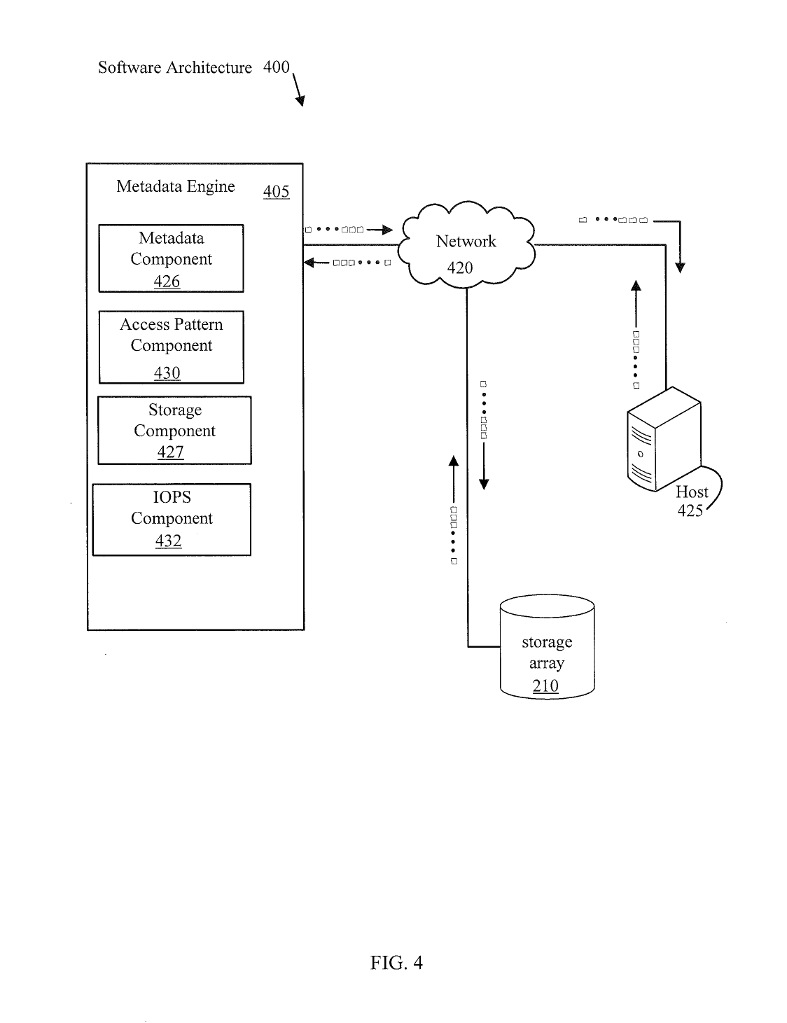

FIG. 4 is a schematic diagram of a computer architecture of embodiments of the invention. The computer architecture 400 includes a metadata engine 405. The metadata engine 405 is in communication with a host 425 and a storage array 210 over a network 420. As illustrated in FIG. 4, metadata engine 405 includes a metadata component 426, an access pattern component 430, a storage component 427 and an IOPS component 432.

Metadata component 426 may maintain object and system metadata. Access pattern component 430 may receive, analyze and generate patterns from I/O access requests 302 of FIG. 3. For example, the access pattern component 430 may determine the number and/or temporal frequency of reads and writes for a given object, file, folder and/or the like. These requests may be grouped with other criteria (e.g., client, local, remote, etc.) to develop or generate patterns. Another embodiment may store aggregated unique chunks of deduplicated data in datastore containers that are written sequentially to HDDs 230 and SSDs 220 of storage array 210. Highly random reads could be detected and directed to the SSDs 220 and sequential reads could be directed to the HDDs 230.

Storage component 427 may be in communication with the host 425, storage array 210 or both. In one embodiment, the storage component 427 may facilitate which data sets are to be stored in SSDs 220 and which are to be stored in HDDs 230. This determination may be based, at least in part, on information received from the access pattern component 430. Without limitation, the storage component 427 may combine information received from the access pattern component 430 with information from transaction logs 310, described above with reference to FIG. 3.

IOPS component 432 may be in communication with host 425, storage array 210 or both. The IOPS component 432 may function with the components 426, 427, 430 to determine how input/output (read/write) requests are routed. For example, the IOPS 432 component may receive an I/O request 302, and based on the request type, send the request 302 to one or more database instances 105, 110, 115, 120 (described in FIG. 1) in the storage array 210. In one embodiment, the IOPS component 432 may also bifurcate access requests 302 by determining whether the request type requires access to hot data, stored in SSDs 220, or cold data, stored in rotating disks HDDs 230, as described in FIG. 2.

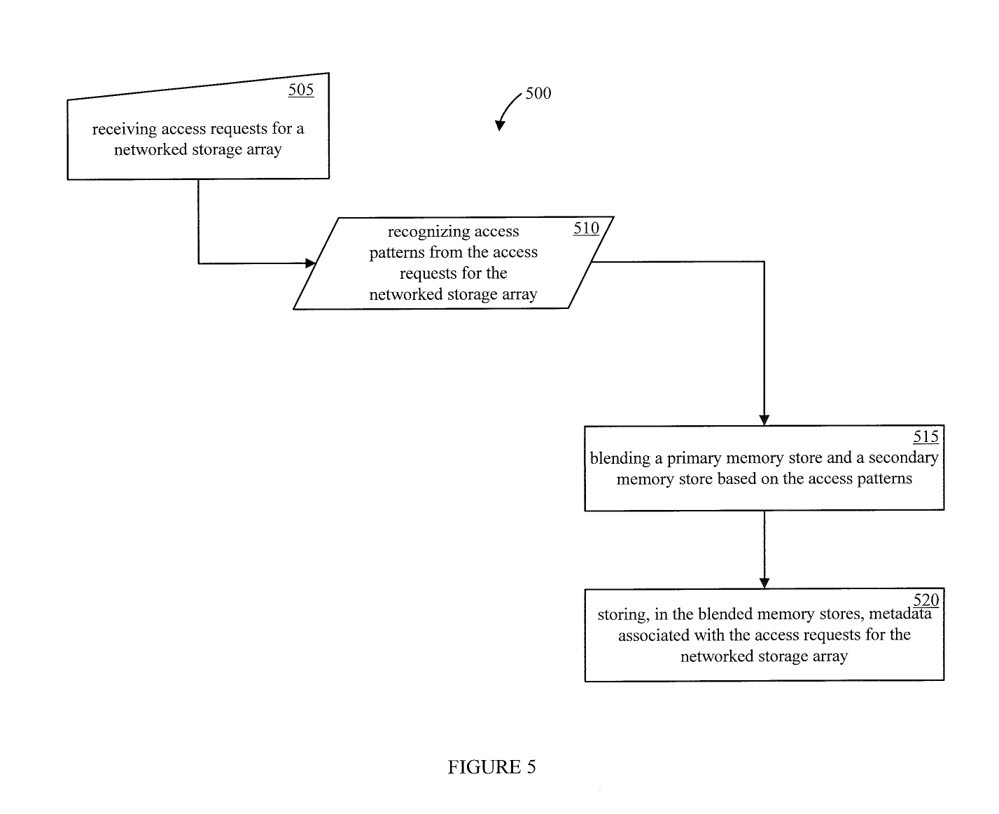

FIG. 5 is a flow diagram illustrating one embodiment of a process for efficient combination of storage devices 220, 230. The process 500 for efficient combination of storage devices 220, 230 may include receiving 505 access requests 302 for a networked storage array 210. From those access requests 302, the process 500 may recognize access patterns 510. In one embodiment, the methods and systems may blend 515 a primary memory store and a secondary memory store based on the access patterns indicated at 520. The process 500 may further store 520, in the blended memory stores 220, 230, metadata associated with the access requests 302 for the networked storage array 210.

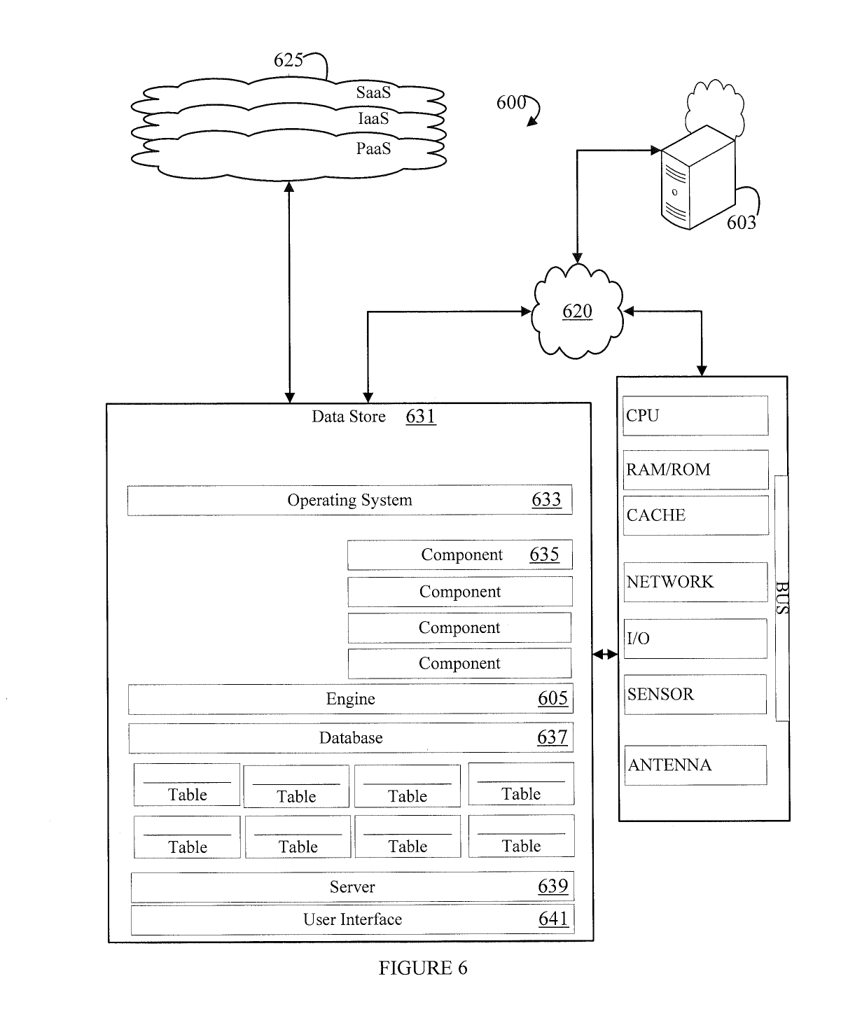

FIG. 6 is a schematic diagram of a computer system 600 for efficient combination of storage devices according to one embodiment. The Efficient Combination system of FIG. 6 may serve to aggregate, process, store, search, serve, identify, instruct, generate, match, and/or facilitate interactions with a computer. Computers employ processors to process information; such processors may be referred to as central processing units (CPU). CPUs use communicative circuits to pass binary encoded signals acting as instructions to enable various operations. These instructions may be operational and/or data instructions containing and/or referencing other instructions and data in various processor accessible and operable areas of memory. Such instruction passing facilitates communication between and among one or more virtual machines, one or more instances of the Metadata engine 405, one or more Metadata engine components 426, 427, 430, 432, as well as third party applications. Should processing requirements dictate a greater amount speed and/or capacity, distributed processors (e.g., Distributed Cache) mainframe, multi-core, parallel, and/or super-computer architectures may similarly be employed. Alternatively, should deployment requirements dictate greater portability, mobile device(s), tablet(s) Personal Digital Assistants (PDAs) may be employed.

The host(s), client(s) and storage array(s) may include transceivers connected to antenna(s), thereby effectuating wireless transmission and reception of various instructions over various protocols; for example the antenna(s) may connect over Wireless Fidelity (WiFi), BLUETOOH, Wireless Access Protocol (WAP), Frequency Modulation (FM), or Global Positioning System (GPS). Such transmission and reception of instructions over protocols may be commonly referred to as communications. In one embodiment, the Metadata engine 405 may facilitate communications through a network 620 between or among a hypervisor and other virtual machines. In one embodiment, the hypervisor and other components may be provisioned as a service. The service 625 may include a Platform-as-a-Service (PaaS) model layer, an Infrastructure-as-a-Service (IaaS) model layer and a Software-as-a-Service (SaaS) model layer. The SaaS model layer generally includes software managed and updated by a central location, deployed over the Internet and provided through an access portal. The PaaS model layer generally provides services to develop, test, deploy, host and maintain applications in an integrated development environment. The IaaS layer model generally includes virtualization, virtual machines, e.g., virtual servers, virtual desktops and/or the like.

Depending on the particular implementation, features of the Efficient Combination system 600 and components of Metadata engine 405 may be achieved by implementing a specifically programmed microcontroller. Implementations of the Efficient Combination system 600 and functions of the components of the Metadata engine include specifically programmed embedded components, such as: Application-Specific Integrated Circuit (“ASIC”), Digital Signal Processing (“DSP”), Field Programmable Gate Array (“FPGA”), and/or the like embedded technology. For example, any of the Efficient Combination Engine Set 605 (distributed or otherwise) and/or features may be implemented via the microprocessor and/or via embedded components. Depending on the particular implementation, the embedded components may include software solutions, hardware solutions, and/or some combination of both hardware/software solutions. For example, Efficient Combination system 600 features discussed herein may be achieved in parallel in a multi-core virtualized environment. Storage interfaces, e.g., data store 631, may accept, communicate, and/or connect to a number of storage devices such as, but not limited to: storage devices, removable disc devices, such as Universal Serial Bus (USB), Solid State Drives (SSD), Random Access Memory (RAM), Read Only Memory (ROM), or the like.

Remote devices may be connected and/or communicate to I/O and/or other facilities of the like such as network interfaces, storage interfaces, directly to the interface bus, system bus, the CPU, and/or the like. Remote devices may include peripheral devices and may be external, internal and/or part of Metadata engine. Peripheral devices may include: antenna, audio devices (e.g., line-in, line-out, microphone input, speakers, etc.), cameras (e.g., still, video, webcam, etc.), external processors (for added capabilities; e.g., crypto devices), printers, scanners, storage devices, transceivers (e.g., cellular, GPS, etc.), video devices (e.g., goggles, monitors, etc.), video sources, visors, and/or the like.

The memory may contain a collection of program and/or database components and/or data such as, but not limited to: operating system component 633, server component 639, user interface component 641; database component 637 and component collection 635. These components may direct or allocate resources to Metadata engine components. A server 603 may include a stored program component that is executed by a CPU. The server may allow for the execution of Metadata engine components through facilities such as an API. The API may facilitate communicate to and/or with other components in a component collection, including itself, and/or facilities of the like. In one embodiment, the server communicates with the Efficient Combination system database 637, component collection 635, a web browser, a remote client, or the like. Access to the Efficient Combination system database may be achieved through a number of database bridge mechanisms such as through scripting languages and through inter-application communication channels. Computer interaction interface elements such as check boxes, cursors, menus, scrollers, and windows similarly facilitate access to Efficient Combination engine components, capabilities, operation, and display of data and computer hardware and operating system resources, and status.

Embodiments may also be implemented as instructions stored on a non-transitory machine-readable medium, which may be read and executed by one or more processors. A non-transient machine-readable medium may include any mechanism for storing or transmitting information in a form readable by a machine, e.g., a computing device 603. For example, a non-transient machine-readable medium may include read only memory (ROM); random access memory (RAM); magnetic disk storage media; optical storage media; flash memory devices; and others.

While this invention has been particularly shown and described with references to example embodiments thereof, it will be understood by those skilled in the art that various changes in form and details may be made therein without departing from the scope of the invention encompassed by the appended claims.

What is claimed is:

1. A method, comprising:
receiving access requests for a networked storage array;
recognizing access patterns from the access requests for the networked storage array;
blending a primary memory store and a secondary memory store based on the access patterns; and
storing, in the blended memory stores, metadata associated with the access requests for the networked storage array.

2. The method of claim 1 wherein receiving access requests includes receiving a series of sequential read requests and sequential write requests.

3. The method of claim 1 wherein recognizing an access pattern includes identifying a random read access pattern or a sequential write access pattern.

4. The method of claim 1 wherein the primary store includes silicon-based memory and the secondary store includes magnetic-based memory.

5. The method of claim 4 wherein the silicon-based memory includes one or more solid state drives and the magnetic-based memory includes one or more rotating magnetic disk drives.

6. The method of claim 1, further comprising:
maintaining metadata associated with the access requests for the networked storage array.

7. The method of claim 1, further comprising:
maintaining object store metadata associated with the access requests for the networked storage array; and
maintaining filesystem metadata associated with the access requests for the networked storage array.

8. The method of claim 7, further comprising:
redundantly storing the object store and filesystem metadata in at least two storage devices.

9. The method of claim 1, further comprising:
associating the access requests as one or more access request types;

10. The method of claim 9, further comprising:
identifying primary store performance characteristics;
identifying secondary store performance characteristics;
determining to store metadata associated with the access requests to the primary data store based, at least in part, on the one or more access request types associated and on the primary store performance characteristics; and
determining to store metadata associated with the access requests to the secondary data store based, at least in part, on the one or more access request types associated and the secondary store performance characteristics.

11. The method of claim 1, further comprising:
instantiating an active database resident in a memory, the active database representing at least a portion of a complete database;
instantiating a merge source database resident in the memory, the merge representing a previous version of the active database; and
instantiating a persistent database based on the active database and the merge source database.

12. The method of claim 1, further comprising:
providing the primary storage in one or more solid state drives; and
providing the secondary storage in one or more magnetic disk drives.
